(19) United States
(12) Patent Application Publication
(10) Pub. No.: US 2010/0005556 A1
(43) Pub. Date: Jan. 14, 2010

(54) VACUUM SEALED PROTECTIVE COVER FOR BALLISTIC PANEL

(76) Inventors: David L. Pittman, Temecula, CA (US); Sharon M. Laird, Wildomar, CA (US)

Correspondence Address: CHRISTIE, PARKER & HALE, LLP, PO BOX 7068, PASADENA, CA, 91109-7068, US

(21) Appl. No.: 12/500,875

(22) Filed: Jul. 10, 2009

Related U.S. Application Data
(60) Provisional application No. 61/079,905, filed on Jul. 11, 2008.

(51) Int. Cl. F41H 1/02; B29C 65/00; B29C 65/08; B29C 65/14

(52) U.S. Cl. 2/2.5; 156/286; 156/73.1; 156/272.2

(57) ABSTRACT

A ballistic panel for use in ballistic apparel having a plurality of layers of ballistic material and a vacuum sealed covering layer surrounding the plurality of layers of ballistic material.

### CROSS-REFERENCE TO RELATED APPLICATION(S)

This application claims priority to and benefit of U.S. Provisional Patent Application No. 61/079,905 filed Jul. 11, 2008.

### FIELD OF THE INVENTION

This invention relates to protective vests, and more particularly to a vacuum sealed protective cover for ballistic panels for soft body armor.

### BACKGROUND OF THE INVENTION

Ballistic vests have saved the lives of many law enforcement officers in recent years. As a result, law enforcement agencies have made it mandatory for their officers to wear ballistic vests while on duty.

Ballistic vests are available as a protective panel having overlying layers of a fabric made from woven high tensile strength fibers. Woven fabrics from an aramid fiber known as Kevlar, for example, have been used successfully in ballistic vests because of the high energy absorption properties of the fabric material. Comfort of the ballistic vest is extremely important, especially to law enforcement officers, because of the heat build up that occurs from wearing a heavy and inflexible vest for long hours while on duty. Resistance to projectile penetration is a principle factor in designing a ballistic vest; and added protective layers can offer greater protection against projectiles having the higher threat levels, but added protective layers also add undesirable weight and inflexibility of the vests.

In addition to woven Kevlar fabric layers, ballistic vests have been made from other high strength fibers and composites to reduce weight and improve flexibility of the vests. However, ballistic vests using the lighter, more flexible materials must offer the required minimum levels of protection against penetration by different types of projectiles. The more flexible the ballistic fabrics are, the more bunching and backface deformation occurs upon impact from a projectile. A vest must not be too flexible where it cannot protect the wearer.

Typically, the plurality of overlying layers of fabric are contained within an outer cover and the combination is commonly referred to as a ballistics package or protective panel for the ballistic vest. The ballistics package, or body armor protective panel, can become damaged which is caused by flexing over multiple years of wear. The ballistics package also can become damaged through moisture accumulation within the ballistics package from varying ambient temperatures through which the vest is exposed over time. The ballistics package can also become damaged from abrasion against the cover, and the cover material becomes damaged by abrasion from the plurality of layers of ballistic material contained therein, or a combination of both, through extended use. Another problem encountered is that because the ballistics package is flexible it can collapse within its cover thereby reducing the area of coverage to the wearer along with causing damage to the ballistics package due to creasing of the multiple layers of ballistic materials.

Therefore, there is a need to provide a ballistic vest that is reasonably light in weight, is thin and is comfortable, is also capable of meeting the high performance projectile specifications of certification testing, and is designed for extended use over a prolonged period of time. Providing such a vest at a reasonably low cost for the comparable high performance level also is a desirable objective. Consequently, a need exists for an improved soft body armor design, namely, to improve ballistic performance and comfort and to prevent premature wear due to abrasion from flexing and moisture accumulation.

### SUMMARY OF THE INVENTION

The present invention provides a ballistic vest of the soft body armor type comprising a plurality of over-laying first flexible layers arranged in a stack on a strike side of the vest, and a plurality of overlying second flexible layers arranged in a stack on a body side of the vest. Each first flexible layer comprises a thin, flexible, woven fabric layer made of high tensile strength polymeric fibers. The individual woven fabric layers form a soft, flexible woven fabric first panel for the vest. Each second flexible layer comprises a thin, flexible imperforate fiber-reinforced sheet comprising an array of fibers embedded in a thermoplastic resin matrix that forms each film sheet. Although this is one example of a ballistics package, any type and number of ballistics packages which meet any threat level are contemplated for use in the present invention. The vests of the present invention preferably is designed to be concealable, however it is to be understood that the inventive concepts are equally applicable to ballistic vests which are worn on the outside of the wearers' clothing or uniforms. The ballistics package of the present invention is equally applicable to other types of protective garments other than vests and can also include non ballistic materials.

The ballistic vest of the present invention incorporates nylon hook fasteners to fasten the front panel to the back panel, and are attached to strapping or conventional elastic. Vests, or other garments of the present invention can also use buckles, zippers and other fastening systems.

More particularly, the ballistic vest of the present invention incorporates a cover for the individual layers of ballistic material, wherein the cover is made from materials which can utilize sealing technologies along its perimeter and drawing a vacuum during the sealing process to evacuate air within the panel. The surfaces of the cover are thereby drawn to the ballistic layers contained therein to provide support for the ballistic package, reduce abrasion during flexing, and reduce moisture build-up due to condensation.

Sealing the perimeter of outer cover for the ballistics package can be by a number of methods. The cover can be constructed of materials made from plastics, woven materials or non-woven materials. The perimeter of the cover can be sealed through ultrasonic welding, radio frequency welding techniques, gluing or taping. The vacuum can be applied during or after assembly of the ballistic package to draw the air from within the cover prior to sealing. The ballistics package, or body armor panel, contemplated by the present invention can include a plurality of layers of ballistic material, non-ballistic material, or any combination thereof. Although it is contemplated that the present invention is suitable for soft-body armor, the materials for the ballistic package can be rigid, semi-rigid, flexible, or any combination thereof.

### BRIEF DESCRIPTION OF THE DRAWINGS

These and/or other features and advantages of the present invention will be more fully understood by reference to the drawings and following detailed description wherein:

FIG. 1 is a front view of a ballistic vest of the present invention;

FIG. 2 is a back view of the ballistic vest of FIG. 1.;

FIG. 3 is a partial cross-sectional view of the front panel of the ballistic vest of the present invention;

FIG. 4 is a detail of FIG. 1 illustrating access to the ballistics panel or package; and

FIG. 5 is a front view of a ballistic package of the vest of FIG. 1 illustrating the sealing and vacuuming process of the cover.

### DETAILED DESCRIPTION OF THE INVENTION

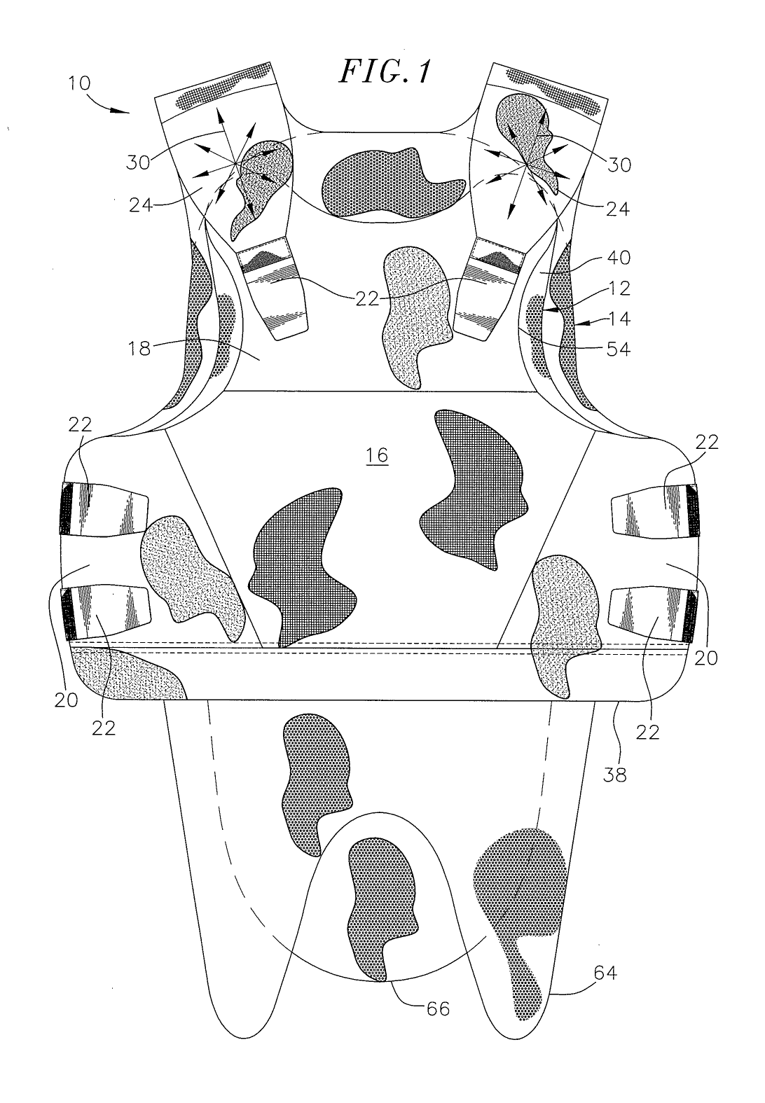

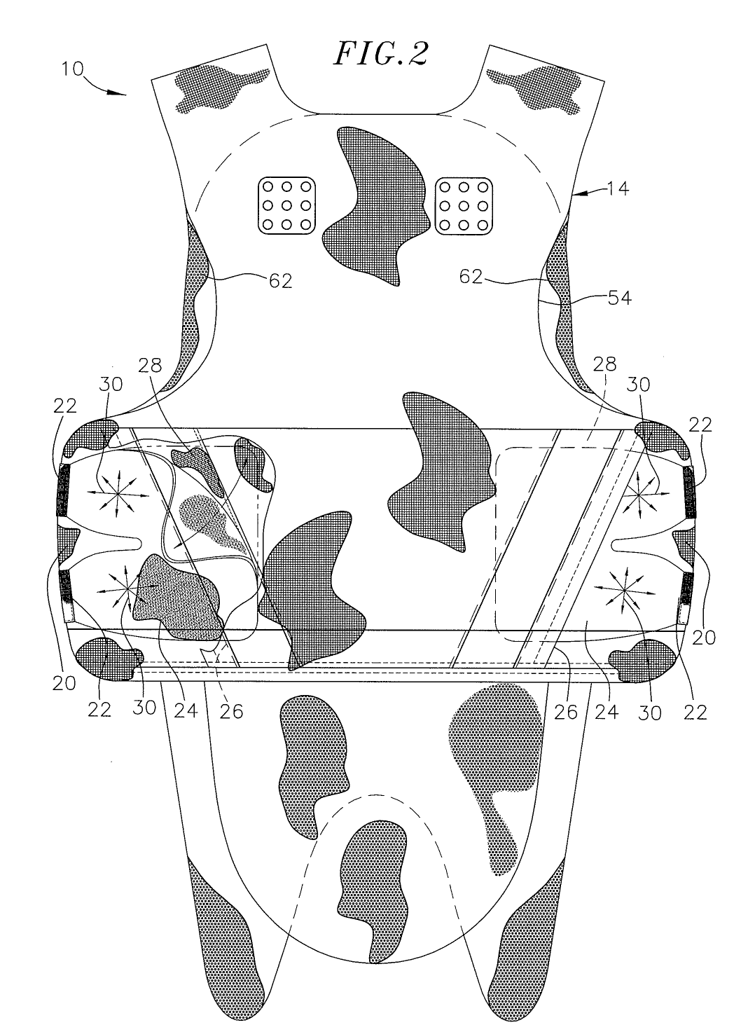

A ballistic vest 10 of the present invention is shown in FIGS. 1 and 2. The ballistic vest 10 is a concealable vest of the soft body armor type commonly worn by law enforcement officers. The ballistic vest includes a front panel 12 and a rear panel 14. The front panel 12 protects the chest and stomach of the wearer while the rear panel 14 protects the back of the wearer.

The front panel 12 may include a center panel 16 and hook compatible fabric located on the top 18 and sides 20 of the front panel 12. Top 18 and sides 20 provide a large area for hook fasteners 22 to secure the front panel and rear panel together around the wearer. Top 18 and sides 20 allow for placement of fasteners 22 at any location to provide an optimal fit for the particular wearer. Straps 24 located at the top and sides of the ballistic vest are attached to the fasteners 22 to secure the front and rear panels together. As seen best in FIG. 2, straps 24 for connecting the top of the front and rear panels can be typically sewn to the rear panel, or as with straps 24 located at the sides of the ballistic vests, can be inserted into a pocket 26 which includes a section of hook fasteners 28, sewn within the pocket, for connection of the straps 24. The pocket arrangement for the straps can be located at the top, sides or both locations of the vest. As indicated by the direction arrows 30, the straps 24 provide for multi-directional adjustment.

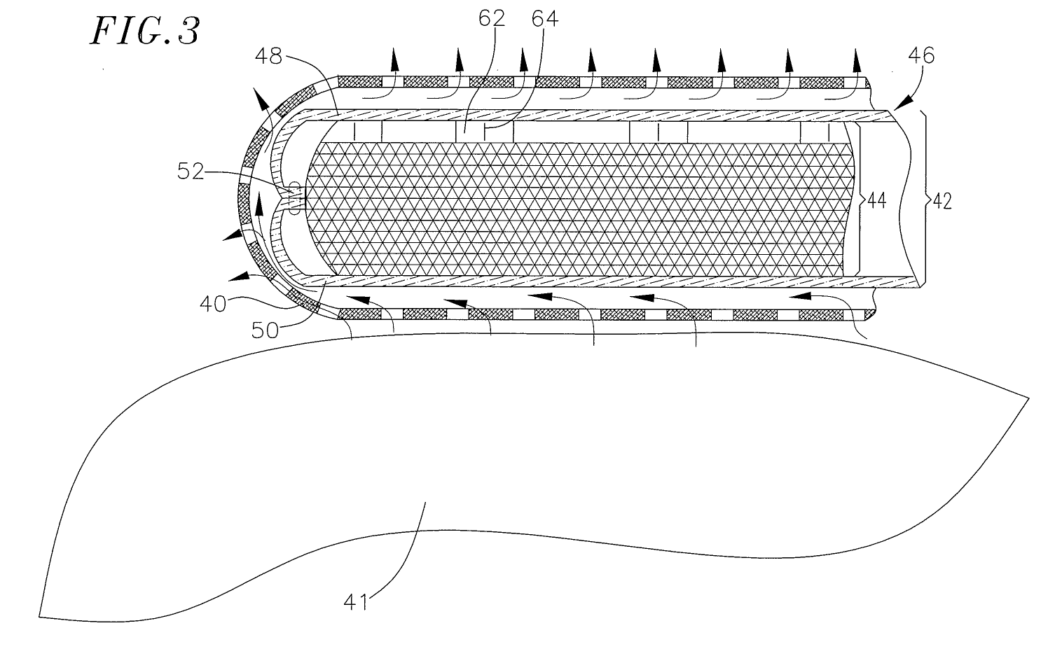

As shown as in FIG. 3, the front panel, as well as the rear panel, includes a lining material 40 which is adjacent the body 41 of the wearer and extends around the edge of the panel to the outside of the ballistic vest. The material can be perforated or of solid construction and is a moisture absorbing material which wicks moisture away from the body and around to the outside of the vest for evaporation. Contained within the lining material 40 is the ballistic panel or package 42 which comprises the individual layers of ballistic material 44 located within a covering layer 46. Layer 46 may comprise a top layer 48 and a bottom layer 50 bonded together at internal seam 52. Layers 48 and 50 can be joined by various methods discussed herein. Air gaps are present between lining material 40 and ballistic material 44 during assembly of the ballistic package. It is these air gaps that create abrasion of and condensation within the ballistic material 44. As shown in FIGS. 1 and 2, the lining material 40 extends around the outside surface of the vest and is sewn to the outside surface of the front and rear panels 18 and 20 to form a seam 54 which allows the ballistics package to extend all the way to the edge of the front and rear panels.

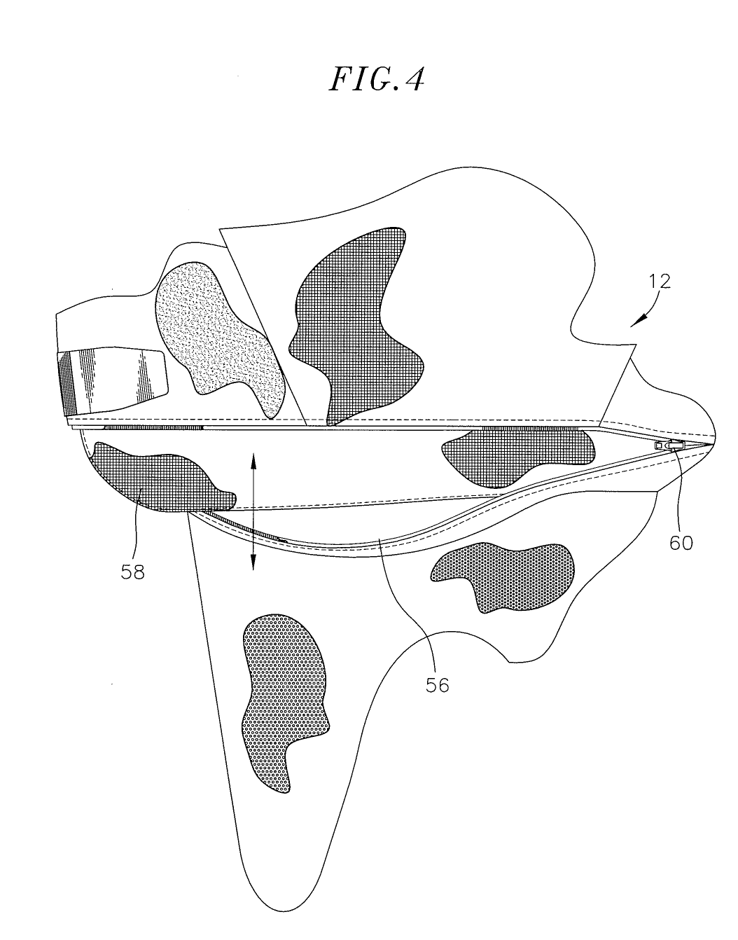

As shown in FIG. 4, the front panel 12 includes an opening 56 for access to the ballistics panel 58. The opening is positioned on the outside of the front panel to produce a smooth surface against the body. A zipper 60 or other suitable closing mechanism extends across the width of the opening. The zipper permits easy access to remove the ballistics panel or package.

As seen in FIG. 2, the ballistic vest includes visual inspection ports 62 positioned on the exterior of the garment. As shown in FIG. 1, retention tails 64 and 66 are sewn to the lower edge 38 of the front and rear panels respectively. Preferably the tails are constructed of stretchable fabrics or meshes which are tucked into a wearer's trousers to hold the vest down during movement.

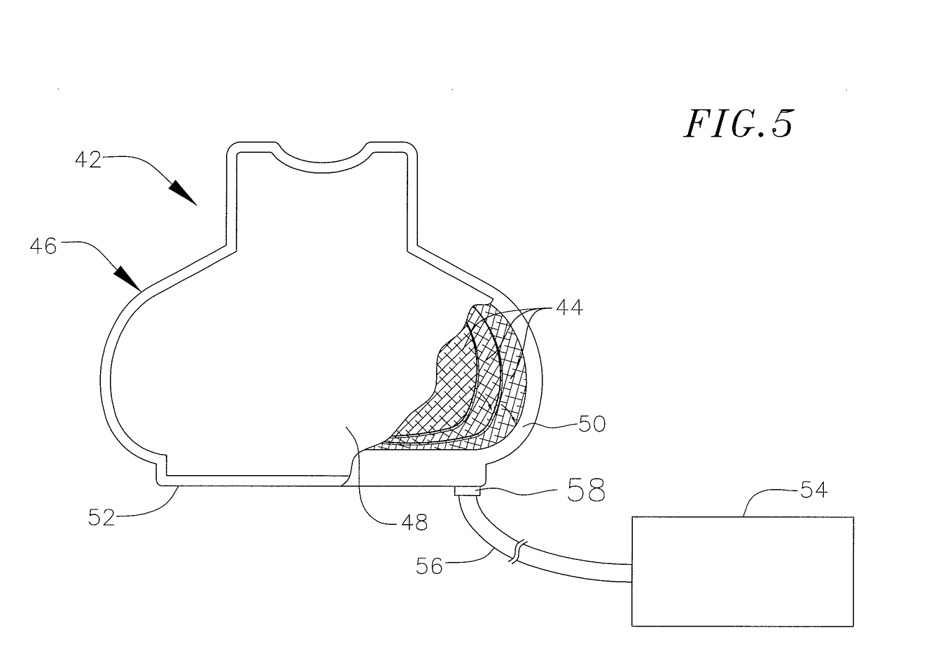

As shown in FIG. 5, the ballistic package or panel 42 of the present invention includes covering layer 46 containing one or more layers of ballistic material 44. The covering layer 46 is constructed such that the top layer 48 and the bottom layer 50 are sealed together along its perimeter 52 in one or more of ultrasonic or radio frequency welding, gluing, or taping, depending upon the specific materials used for the layers. The layers can be made from a woven fabric of aramid fiber or other woven fabric layer of high tensile strength polymeric fibers, or non-woven fabric made of thermal plastic resin either with or without an array of fibers embedded within the thermal plastic resin matrix. In essence, any material made of plastics, a woven or non-woven material can serve as the covering layer. The specific sealing technique utilized would be the one most appropriate for the type of material used for the covering layer.

Once the top and bottom covering layers are sealed, a vacuum is applied to draw the air from inside the covering layer thereby compressing the covering layer and the plurality of ballistic sheets 44. For example, vacuum 54 includes a hose 56 attached to a connector 58 to evacuate a prescribed amount of air from inside the ballistic panel. Once the prescribed amount of air is evacuated, the hose is disconnected from the connector 58 and the connector is sealed. The inside surfaces of the top and bottom layers of the covering layer are drawn to the ballistic materials during the vacuuming operation and therefore help support the ballistic panel, reduce abrasion during flexing, and reduce moisture build-up due to condensation as the interior is sealed from moisture.

Although the present invention has been shown and illustrated with respect to an embodiment thereof, the invention is not to be so limited since changes and modifications can be made therein which are within the scope of the invention as hereinafter claimed.

What is claimed is:

1. A ballistic panel for use in ballistic apparel comprising:
a plurality of layers of ballistic material; and
a vacuum sealed covering layer surrounding the plurality of layers of ballistic material.

2. The panel of claim 1 wherein the vacuum sealed covering layer comprises a top layer and a bottom layer sealed by ultrasonic welding.

3. The panel of claim 1 wherein the vacuum sealed covering layer comprises a top layer and a bottom layer sealed along a perimeter by radio frequency welding.

4. The panel of claim 1 wherein the vacuum sealed covering layer comprises a top layer and a bottom layer glued together.

5. The ballistic panel of claim 1 wherein the vacuum sealed covering layer comprises a top layer and a bottom layer sealed along a perimeter by tape.

6. The ballistic panel of claim 1 wherein the vacuum sealed covering layer further includes a sealable connector positioned along a perimeter of the covering layer to provide a connection for applying a vacuum to the ballistic panel.

7. The ballistic vest comprising:
a front panel;
a rear panel;
at least one of the front and rear panels having a ballistic panel comprising a plurality of layers of ballistic material positioned within a vacuum sealed covering layer; and
connectors for attaching the front and rear panels together.

8. The vest of claim 7 wherein the vacuum sealed covering layer comprises a top layer and a bottom layer sealed by ultrasonic welding.

9. The vest of claim 7 wherein the vacuum sealed covering layer comprises a top layer and a bottom layer sealed along a perimeter by radio frequency welding.

10. The vest of claim 7 wherein the vacuum sealed covering layer comprises a top layer and a bottom layer glued together.

11. The vest of claim 7 wherein the vacuum sealed covering layer comprises a top layer and a bottom layer sealed along a perimeter by tape.

12. The vest of claim 7 wherein the vacuum sealed covering layer further includes a sealable connector positioned along a perimeter of the covering layer to provide a connection for applying a vacuum to the ballistic panel.

13. A method of manufacturing a ballistic panel comprising the steps of:
stacking a plurality of layers of ballistic sheets on top of one another;
positioning a top covering layer and a bottom covering layer over the plurality of layers of ballistic materials;
sealing a perimeter of the top covering layer to the bottom covering layer around a perimeter of the top covering layer and the bottom covering layer; and
evacuating a prescribed amount of air from the ballistic panel in between the top covering layer and the bottom covering layer.

14. The method of claim 13 wherein sealing the top covering layer to the bottom covering layer is by ultrasonic welding.

15. The method of claim 13 wherein sealing the top covering layer to the bottom covering layer is by radio frequency welding.

16. The method of claim 13 wherein sealing the top covering layer to the bottom covering layer is by gluing.

17. The method of claim 13 wherein sealing the top covering layer to the bottom covering layer is by taping.

18. The method of claim 13 wherein a sealable connector is positioned along the perimeter of the top covering layer and the bottom covering layer to provide a connection for applying a vacuum to the ballistic panel.
